(19) United States
(12) Patent Application Publication
(10) Pub. No.: US 2006/0105874 A1
(43) Pub. Date: May 18, 2006

(54) Timing belt

(75) Inventor: Kaoru Shimamura, Saitama (JP)

Correspondence Address: ARENT FOX PLLC, 1050 CONNECTICUT AVENUE, N.W., SUITE 400, WASHINGTON, DC, 20036, US

(73) Assignee: Honda Motor Co., Ltd.

(21) Appl. No.: 11/272,687

(22) Filed: Nov. 15, 2005

(30) Foreign Application Priority Data
Nov. 16, 2004 (JP) 2004-331869

(51) Int. Cl. F16G 1/04

(52) U.S. Cl. 474/266; 474/237

(57) ABSTRACT

It is an object of the present invention to provide a timing belt capable of strengthening the tensile rigidity of a belt, preventing the local flexure of the core wire due to polygon engagement by adjusting flexibility on the outer circumferential side of a pitch line, and having improved flexural fatigue resistance of a belt. A timing belt (1) comprises: a ring-shaped belt body (3); a plurality of tooth parts (2) formed at predetermined intervals along the inner peripheral surface of the belt body (3); a core wire (6) buried along the circumferential direction of the belt body (3); and an intermediate canvas (7) provided on the outer circumferential side of the core wire (6) in the belt body (3), wherein the intermediate canvas (7) has retractility in the circumferential direction.

### BACKGROUND OF THE INVENTION

1. Field of the Invention

The present invention relates to a timing belt synchronously transmitting.

2. Description of the Prior Art

A timing belt is a belt on which teeth lined at predetermined intervals along the circumferential direction on the inner circumferential side of a ring-shaped belt body are formed, and is suitable for use application requiring a synchronous rotation. Though examples of methods for transmitting exact rotational movement include a gear and a chain, the timing belt has advantages such as small noise, no oil supply and small transfer error.

For example, the timing belt is used as a belt for the synchronous transmission of an engine crankshaft and cam of a car. In addition, the timing belt is used for all belt transmission systems requiring synchronous transmission such as precision instruments such as a camera, a computer and a copying machine and general industrial machines.

Particularly, the timing belt for transmitting power to each part of the engine of a car is easily deteriorated because the number of times of flexures is increased with the aggravation of the heat environment accompanying the high output of the engine and the formation of a small pulley due to engine miniaturization. That is, since the use environment of the timing belt has been demanding in recent years, designs with emphasis on intensity and durability are required for the timing belt (for example, refer to Japanese Published Unexamined Patent Application No. H6-213282, particularly, Paragraph 0030, FIG. 2)

Herein, the constitution of the conventional timing belt will be explained. FIG. 6 is a sectional perspective view showing a part of a conventional timing belt.

As shown in FIG. 6, a conventional timing belt 1′ comprises a ring-shaped belt body 3′, a plurality of tooth parts 2′ formed at predetermined intervals along the inner peripheral surface of the belt body 3′, a tooth cloth 4′ covering the surface of the tooth part 2′, and a core wire 6′ buried along the circumferential direction of the belt body 3′. When this configuration is employed, the upped intensity and high rigidity in the tensile direction of the belt body 3′ are attained by the core wire 6′, and the deformation and wear of tooth parts 2′ are prevented by the tooth cloth 4′.

However, it can be hardly said that the conventional reinforcement method is necessarily sufficient in the timing belt of which the use conditions have become severe in recent years. More than comparable intensity and durability are required for the timing belt with an increase in required driving force and increase in belt resonance load. With the further formation of the small pulley and the increase in the number of times of flexure, it is necessary to enhance flexural fatigue resistance.

Therefore, it is an object of the present invention to provide a timing belt capable of strengthening the tensile rigidity of the belt, reducing polygon engagement by adjusting flexibility on the outer circumferential side of a pitch line, and having improved flexural fatigue resistance. Simultaneously, problems such as the prevention of longitudinal tear due to high load drive and side surface wear can also be handled.

### SUMMARY OF THE INVENTION

The present invention provides a timing belt comprising: a ring-shaped belt body; a plurality of tooth parts formed at predetermined intervals along the inner peripheral surface of the belt body; a core wire buried along the circumferential direction of the belt body; and an intermediate canvas provided on the outer circumferential side of the core wire in the belt body, wherein the intermediate canvas has retractility in the circumferential direction.

When this configuration is employed, the rigidity of the belt body can be strengthened by the intermediate canvas. Simultaneously, the intermediate canvas has retractility in the circumferential direction, and thereby the intermediate canvas can be expanded and contracted in the circumferential direction on the outer circumferential side of the pitch line, and the bending stress generated according to the flexure of the belt can appropriately be dispersed. The longitudinal tear of the belt and wear of the side surface can be suppressed and the tensile strength can be improved by providing the intermediate canvas.

By providing the intermediate canvas on the outer circumferential side from the core wire, the flexural rigidity of the core wire can be enhanced, and the local stress concentration due to polygon engagement can be dispersed.

Since a rubber layer is formed by vulcanization adhesion between the core wire and the intermediate canvas, direct interference of the core wire and canvas can be prevented, and the strength reduction of the fiber caused by a cut or the like can be prevented.

Furthermore, the timing belt capable of grinding the outer peripheral surface can be provided by burying the intermediate canvas in the belt body.

Furthermore, since the belt body has an outer peripheral surface ground so as to make the thicknesses of the belt body uniform, tension change generated by the thickness unevenness of a back tensioner contact part can be suppressed, and noise and vibration at the time of a belt traveling can be suppressed.

Furthermore, the intermediate canvas is woven by the woofs along the circumferential direction and the warps along the width direction, the woof is formed of organic fibers, and the warp can be formed of organic fibers or inorganic fibers.

Furthermore, since the woof is made of a processed yarn having retractility, the woof can give retractility in the circumferential direction of the intermediate canvas.

Furthermore, since the processed yarn is crimp-processed, the processed yarn can be provided with retractility.

Furthermore, since the processed yarn having retractility is constituted by winding at least one pile or more of covering yarns around the outer circumferential side of core yarns by using elastic yarns having retractility as the core yarns, a method for giving the retractility to the woof can be provided.

Furthermore, since the warp is made of aromatic nylon or carbon fiber particularly excelling in tensile strength besides polyester fiber and polyamide fiber, the longitudinal tear of the timing belt can positively be prevented. Furthermore, when the side surface of the belt slides with a pulley flange, the wear of the side surface of the belt can be decreased.

Furthermore, since the woof and warp are a twisted yarn having a diameter of 100 deniers to 2000 deniers, the rigidity of the intermediate canvas can be enhanced, and a yarn having a diameter capable of being appropriately woven can be provided. The thickness of the intermediate canvas can be appropriately adjusted according to vulcanization molding conditions.

Furthermore, since the surface of the intermediate canvas is subjected to adhesive processing, the durability of the timing belt can be enhanced by not only binding to the rubber but also protecting the fiber itself.

### BRIEF DESCRIPTION OF THE DRAWINGS

FIG. 1 is a sectional perspective view showing a part of a timing belt as one embodiment of the present invention;

FIG. 2 is a schematic diagram for explaining a double covered yarn using an elastic yarn having retractility as a core yarn;

FIG. 3 is a partial enlarged view when winding each member into a cylinder around a molding die before vulcanization molding in this embodiment;

FIG. 4 is a perspective view for explaining a method for covering the molding die before vulcanization molding with an intermediate canvas in this embodiment;

FIG. 5 is a partial enlarged view showing the constitution of a belt material integrally formed after vulcanization molding in this embodiment; and

FIG. 6 is a sectional perspective view showing a part of a timing belt as a conventional embodiment.

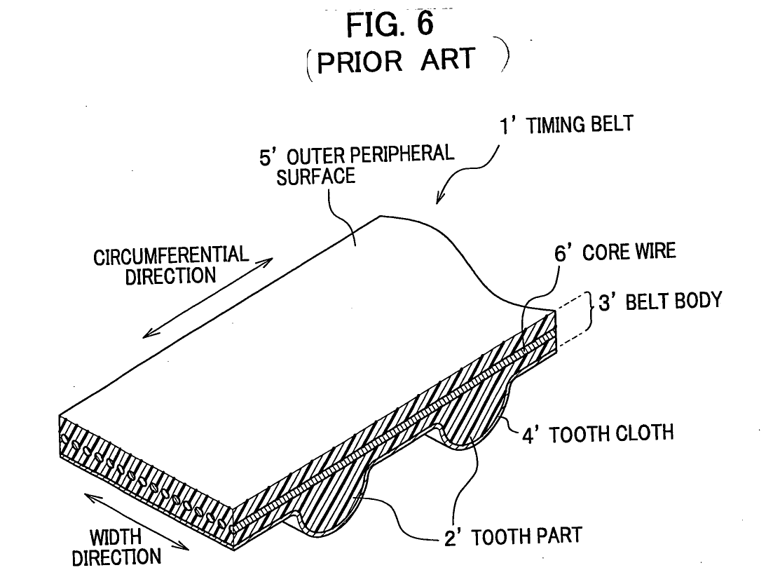

### DETAILED DESCRIPTION OF THE PREFERRED EMBODIMENT

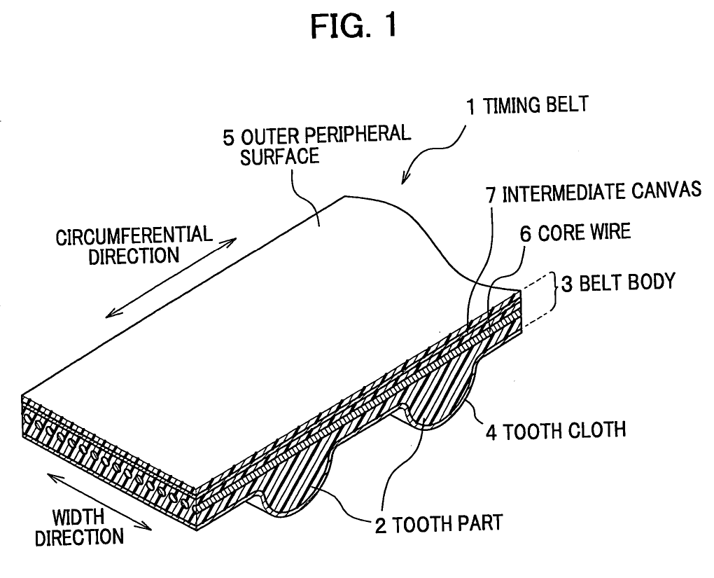

Hereinafter, the best mode of the present invention will be explained in detail with reference to the appropriate drawings. FIG. 1 is a sectional perspective view showing a part of the timing belt of the embodiment. Since the timing belt is usually used in severe environments where the timing belt is easily deteriorated, such as a rise of an atmosphere temperature and contact of engine oil and cooling water, durability capable of enduring the environments is required.

As shown in FIG. 1, a timing belt 1 comprises: a ring-shaped belt body 3; a plurality of tooth parts 2 formed at predetermined intervals along the inner peripheral surface of the belt body 3; a tooth cloth 4 covering the surface of the tooth part 2; a core wire 6 buried along the circumferential direction of the belt body 3; and an intermediate canvas 7 provided on the outer circumferential side of the core wire 6 in the belt body 3.

The intermediate canvas 7 is provided so as to reinforce the belt body 3 to be described below. Heat resistance, oil resistance, water resistance, muddy water resistance and weatherability or the like are required in view of the use environments of the timing belt 1 besides the rigidity and abrasion resistance required as a reinforcing member.

The intermediate canvas 7 is formed of a woven material woven by woofs along the circumferential direction of the belt body 3 and warps along the width direction, and is buried in a member constituting the belt body 3 so as not to be exposed to the outer peripheral surface 5 of the belt body 3.

The processed yarn processed so as to have retractility is used for the woof. Thereby, the retractility in the circumferential direction is given to the intermediate canvas 7. For example, aliphatic nylon and aromatic nylon or the like are suitable for the raw yarn of the processed yarn.

A crimping processing can be mentioned as one method for giving retractility to the woof. For example, a hard twisting heat treatment method for twisting yarns of two or more and returning the twisting after heat treatment is preferable.

Otherwise, crimping property can be given by a method (pushing method) for pushing the bundle of filaments into a narrow clearance, a method (heating gear method) for mechanically pushing against a mold to give a waveform to yarn, and a method (contraction heat treatment method) for giving spiral crimping to a composite fiber consisting of two components of which heat contractility is different by heat treatment or the like.

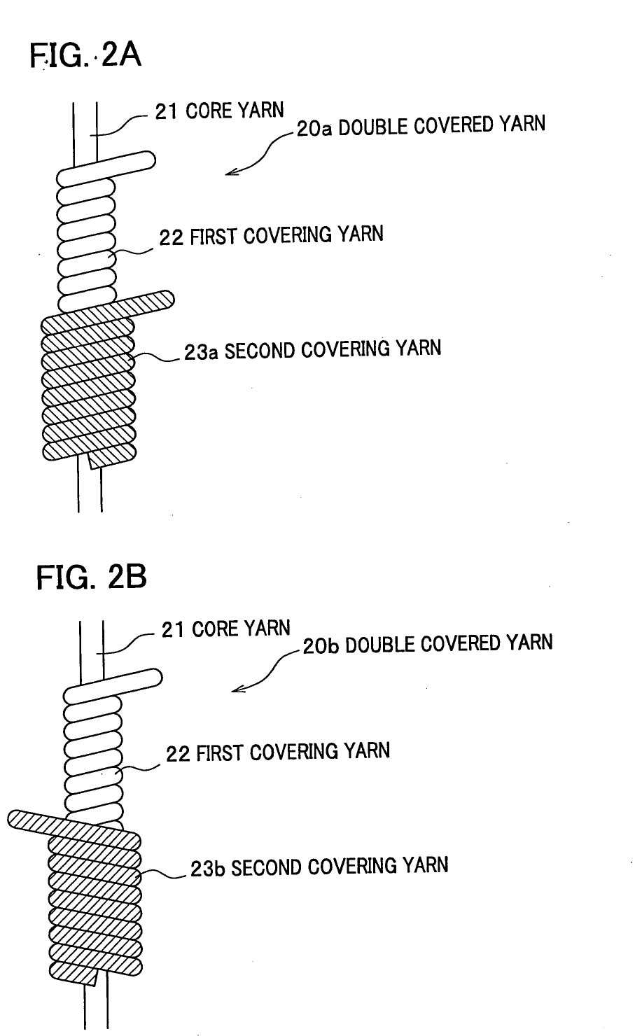

Other methods for giving retractility to the woof include a method for processing as compound yarn. For example, as shown in FIG. 2 (a), a double covered yarn 20a using an elastic yarn having retractility as a core yarn 21 is preferable. In this embodiment, the double covered yarn 20a is constituted by beaming (lower) a first covering yarn 22 excelling in heat resistance around the core yarn 21 using a polyurethane-based elastic yarn or the like having retractility as the core yarn 21, and beaming (upper) a second covering yarn 23a excelling in wear resistance in the same direction as the winding of the first covering yarn 22 on the outside. Aromatic nylon excelling in heat resistance and rigidity is preferable for the first covering yarn 22, and aliphatic nylon excelling in adhesiveness is preferable for the second covering yarn 23a. As long as the compound yarn can satisfy retractility, the first covering yarn 22 and the second covering yarn 23a may be a filament yarn, and may be a crimped yarn or a spun yarn.

The configuration of the covered yarn is not limited to the above ones. For example, as shown in FIG. 2 (b), a double covered yarn 23b is constituted by beaming (upper) the second covering yarn 23b in a direction the reverse of the first covering yarn 22 beamed (lower). Or the double covered yarn 23b may be a single covered yarn obtained by twisting one aromatic nylon fiber or aliphatic nylon fiber, as the covering yarn, to elastic yarns or the like having retractility as the core yarn 21. The double covered yarn 23b may be constituted by twisting the covering yarn of three piles or more to the core yarn 21.

Not only the covering yarn but also the core yarn 21 are not limited to the above ones. For example, the core yarn 21 may be constituted by not one elastic yarn but a plurality of elastic yarns.

An explanation will be continued with reference to FIG. 1 again. The warp of the intermediate canvas 7 can be constituted by a filament yarn of an organic fiber having non-retractility and excelling in rigidity and heat resistance such as aromatic nylon, besides polyester fiber and polyamide fiber generally used. It is particularly preferable that PBO (registered trademark: manufactured by Toray Industries, Inc.) and Vectran (registered trademark: manufactured by Kuraray Co., Ltd.) have high rigidity among aromatic nylon fibers. Or the warp can also be constituted by inorganic fibers such as carbon fiber excelling in rigidity.

With the warp constituted as this, the traveling of the belt can be stabilized by preventing the longitudinal tear of the timing belt 1 and by suppressing the twisting of the belt. When the side surface of the belt slides with the pulley flange, the wear of the side surface of the belt can be decreased by the effect of the intermediate canvas 7 exposed to the side surface.

The woof and warp may be woven after twisting the woof and warp and setting the woof and warp to a predetermined diameter respectively so as to enhance the rigidity of the intermediate canvas 7. It is preferable that the diameters of the twisted yarn of the woof and warp are respectively within the range of 100 d to 2000 d (d: denier) in this embodiment. This is because twisted yarn of 100 d or more is effective for enhancing the rigidity of the intermediate canvas 7, and suitable weaving becomes difficult in the twisted yarn of 2000 d or more.

The bond with rubber is enhanced by subjecting adhesive processing such as RFL (resorcin-formalin-latex) processing and rubber cement processing to the intermediate canvas 7. Furthermore, the fiber itself of the intermediate canvas 7 can be protected by the adhesive processing.

It is preferable that an RFL solution for processing the intermediate canvas 7 has a composition in which the ratio of a resorcin-formalin condensation product is high as compared with the RFL solution for processing the core wire 6 made of glass fiber to be described below.

The intermediate canvas 7 or one having excellent adhesiveness with the rubber cement to be described below are suitably selected as latex of the RFL solution. Specifically, latexes such as a chloroprene rubber (CR), an ethylene propylene diene terpolymer rubber (EPDM), an alkylated chlorosulfonated polyethylene rubber (ACSM), a chlorosulfonated polyethylene rubber (CSM), an acrylonitrile butadiene rubber (NBR) and hydrogenated NBR (H-NBR) or the like can be applied. The best one can be suitably selected for the latex component, and the latex component is not limited to the above examples.

For example, it has been well known that excellent adhesive strength is obtained by using vinyl pyridine latex when the aliphatic nylon is selected for the intermediate canvas 7.

The intermediate canvas 7 on which the RFL film is formed can be subjected to rubber cement processing.

For example, one obtained by dissolving adhesives such as isocyanate simultaneously is used for rubber cement by using rubber compatible with the rubber component of the timing belt 1.

The adhesive strength between the intermediate canvas 7 and the rubber of the belt body 3 is increased by covering the intermediate canvas 7 with both RLF processing and rubber cement processing in this embodiment. However, when sufficient adhesive strength is obtained by one of RFL processing and rubber cement processing, only one processing may be used.

The tooth part 2 and the belt body 3 are formed of a rubber material. The outer peripheral surface 5 of the belt body 3 is ground, and has a uniform thickness. Even when a back tensioner is provided on the outer peripheral surface 5 of the belt by the grind, a pitch line does not fluctuate at the time of the belt traveling, and does not deviate in one direction of right and left to the belt traveling direction. The noise and vibration can be suppressed at the time of the belt traveling due to the tension fluctuation of the belt.

Though it is preferable that the rubber component of the tooth part 2 is the same as that of the belt body 3, the tooth part 2 and the belt body 3 may be constituted by a different rubber component as long as the rubber component has excellent adhesion.

For example, the core wire 6 is obtained by twisting organic fibers such as polyester, aliphatic nylon and aromatic nylon, or inorganic fibers such as glass to form them in a suitable cord according to the use of the belt and by subjecting them to hot stretching processing and adhesion processing. Among the fibers, glass fiber is usually selected in many cases in view of the stretching characteristic, versatility, price and easy application to the manufacturing process of the timing belt 1.

The adhesion processing of the RFL processing and rubber cement processing may be applied to the core wire 6.

For example, the tooth cloth 4 is formed of a woven material woven by organic fibers excelling in wear resistance such as aliphatic nylon. In this embodiment, the intermediate canvas 7 and the tooth cloth 4 may be woven by the same raw yarn or processed yarn in view of easy application to a manufacturing process, or may be woven in the same weaving method.

Fundamentally, the organic fiber for weaving the tooth cloth 4 is selected with emphasis on abrasion resistance. On the other hand, the organic fiber for weaving the intermediate canvas 7 is selected with emphasis on adhesiveness with rubber or the like of the belt body 3 and heat resistance. While the tooth cloth 4 is woven by a weaving method with emphasis on wear resistance and low friction, the intermediate canvas 7 is woven by a weaving method with emphasis on retractility to the circumferential direction.

The adhesion processing of the RFL processing and rubber cement processing may be applied to the tooth cloth 4. In this embodiment, the intermediate canvas 7 and the tooth cloth 4 may be subjected to the same adhesion processing in view of easy application to a manufacturing process.

Fundamentally, the RFL solution and rubber cement for subjecting the tooth cloth 4 to adhesion processing are selected with emphasis on heat resistance, wear resistance and low friction. On the other hand, the RFL solution and rubber cement for subjecting the intermediate canvas 7 to adhesion processing are selected with emphasis on adhesiveness with the rubber of the belt body 3.

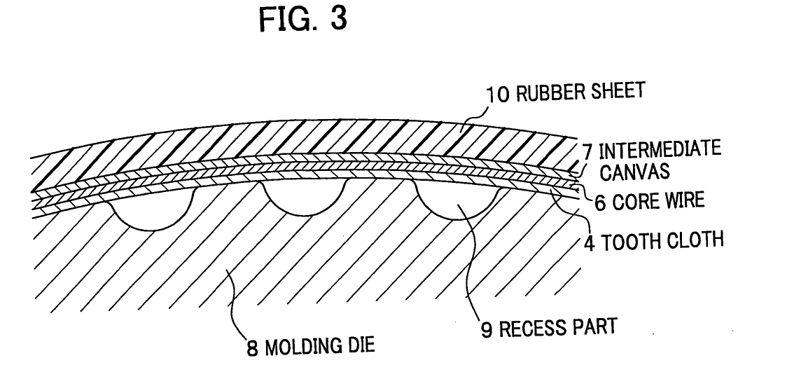

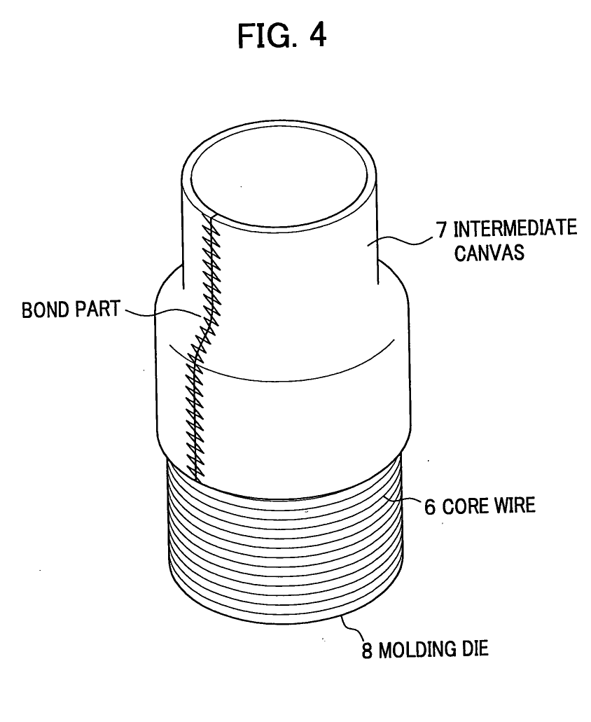

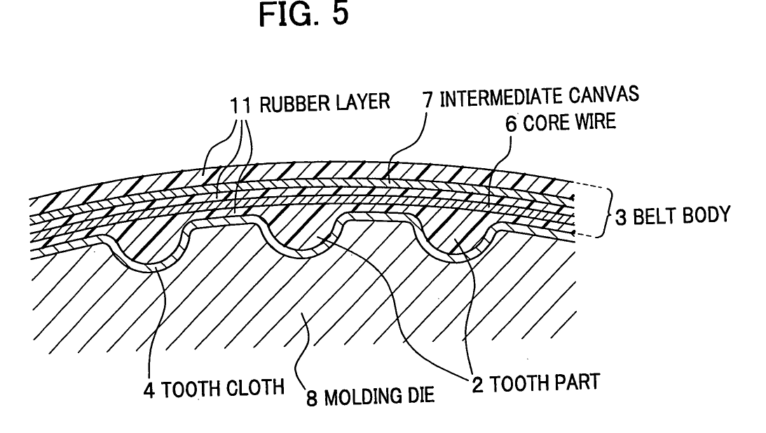

The manufacturing method of the timing belt 1 of the embodiment will be explained with reference to FIGS. 3 to 5. FIG. 3 is a partial enlarged view when winding each member into a cylinder around a molding die before vulcanization molding. FIG. 4 is a perspective view for explaining a method for covering the molding die before vulcanization molding with an intermediate canvas. FIG. 5 is a partial enlarged view showing the constitution of a belt material integrally formed after vulcanization molding.

The timing belt 1 is usually manufactured by using a cylindrical molding die 8 on which a mass of gear-like strip grooves are arranged at equal intervals along the axial direction of the outer peripheral surface so as to form an engagement surface.

After RFL processing and rubber cement processing are previously applied to the intermediate canvas 7, the intermediate canvas 7 is cut into a predetermined size, and the cylindrical intermediate canvas 7 is prepared by bonding the countered two sides of the rectangular intermediate canvas 7.

At this time, the woof subjected to retractility processing is coincided with the circumferential direction in the bond part. For example, two end faces are bonded in a state that the two end faces are mutually countered by suture processing, laser welding or ultrasonic welding to form an endless canvas (refer to the bond part of FIG. 4).

As shown in FIG. 3, the tooth cloth 4 (or containing tooth cloth to which the rubber sheet used for the tooth part 2 is pressure-bonded) is twisted around the cylindrical molding die 8, and the core wire 6 subjected to adhesion processing is spirally twisted around the outer circumferential side while a fixed tension is operated.

As shown in FIG. 4, the cylindrical intermediate canvas 7 is placed by using the retractility of the circumferential direction on the outer circumferential side, and a rubber sheet 10 is further twisted around the outer circumferential side (refer to FIG. 3).

The whole is covered by fitting a sleeve for vulcanization (not shown), and the sleeve is vulcanized under a predetermined condition (temperature, pressure and time) using a known steam vulcanizing pan.

The rubber of a fluidized rubber sheet 10 is press-fitted between tooth cloth 4 and a core wire 6 and between a core wire 6 and intermediate canvas 7, and the rubber layer 11 is formed by the steam pressure in that case, as shown in FIG. 5 when it is heated with high-pressure steam. At the same time, the tooth part 2 is formed by press-fitting the rubber in the recess part 9 of the molding die 8. At this time, the tooth cloth 4 is pressed into the recess part 9 of the molding die 8 with the fluidized rubber, and the surface of the tooth part 2 is covered with the tooth cloth 4.

The tooth cloth 4, the tooth part 2, the core wire 6, the intermediate canvas 7 and the belt body 3 can be integrally vulcanized and formed by passing through the process. Since vulcanization processing is conventionally known, detailed explanation is omitted.

After the rubber sheet is twisted around not only the outer circumferential side of the intermediate canvas 7 but also the inner circumferential side of the intermediate canvas 7 (the outer circumferential side of a layer on which the core wire 6 is twisted in the molding die 8), the rubber sheet may be vulcanized and formed. When this configuration is employed, the rubber layer 11 containing the tooth part 2 can be more reliably formed.

The timing belt 1 is obtained from the cylindrical belt material taken out from the steam vulcanizing pan after vulcanization molding. Specifically, after grinding the outer peripheral surface 5 of the cylindrical belt material released from the mold to a predetermined thickness by a roll grinder or the like, the cylindrical belt material is cut into round slices with a prescribed width, and a plurality of timing belts 1 are obtained.

According to the above, the following effects can be acquired in the embodiment.

The timing belt 1 can be reinforced by providing the intermediate canvas 7 on the timing belt 1. Specific examples of the reinforcements include the improvement in tensile strength in the circumferential direction and width direction of the belt, and suppression of wear of the side surface and longitudinal tear of the belt. Furthermore, the natural frequency of the timing belt 1 can be adjusted by providing the intermediate canvas 7 made of a material different from that of the rubber of the belt body 3 on the belt body 3.

The outer peripheral surface 5 can be ground by burying intermediate canvas 7 between the core wire 6 and outer peripheral surface 5, without exposing intermediate canvas 7 to the outer peripheral surface 5. As a result, stable traveling movement with little side runout can be provided, and noise and vibration at the time of the belt traveling due to the tension change of the belt can be suppressed.

The local flexure of the core wire 6 due to polygon engagement can be prevented by the intermediate canvas 7 being buried. Furthermore, the flexural rigidity of the timing belt 1 can be adjusted by adjusting the retractility of the intermediate canvas 7.

According to the manufacturing method of the timing belt 1 of the embodiment, since the intermediate canvas 7 can be formed while the fixed tension is acted to the intermediate canvas 7 by attaching the intermediate canvas 7 to the molding die 8 before vulcanization molding after making the intermediate canvas 7 as an endless canvas, the whole thickness of the intermediate canvas 7 can be made uniform.

The present invention is not limited to the embodiment, and various modified implementations can be performed within the scope that reaches the technical idea.

For example, the intermediate canvas 7 need not be necessarily buried between the outer peripheral surface 5 and the core wire 6. The intermediate canvas 7 may be exposed from the outer peripheral surface 5 of the belt body 3.

The number of intermediate canvases 7 to be set is not limited to one. Intermediate canvases 7 of two or more may be set on the belt body 3.

Furthermore, the intermediate canvas 7 to be buried need not be necessarily extended in the width direction of the whole belt. In the range playing a role of reinforcing canvas, the intermediate canvas 7 may be short in the width direction. When this configuration is employed, the rubber layer 11 can be partially continued in the thickness direction of the belt on the same plane as the buried intermediate canvas 7, and the timing belt 1 can be provided in view of rigidity in the thickness direction.

Though the retractility in the circumferential direction of the intermediate canvas 7 mainly depends on the retractility of the woof in this embodiment, further retractility to the circumferential direction may be exhibited depending on the weaving method. For example, retractility can be exhibited by a 2/2 diagonal weave and four-sheet sateen weave or the like. The retractility may also be exhibited by a bias cloth arranged so that the weave direction is inclined to the circumferential direction.

According to the present invention, the tensile rigidity of the belt can be strengthened, and the timing belt capable of reducing the polygon engagement by adjusting the flexibility on the outer circumferential side of the pitch line, and having improved flexural fatigue resistance can be provided. Simultaneously, problems such as the prevention of longitudinal tear due to high load drive and side surface wear can also be handled.

What is claimed is:

1. A timing belt comprising: a ring-shaped belt body;
a plurality of tooth parts formed at predetermined intervals along the inner peripheral surface of the belt body;
a core wire buried along the circumferential direction of the belt body; and
an intermediate canvas provided on the outer circumferential side of the core wire in the belt body,
wherein the intermediate canvas has retractility in the circumferential direction, and a rubber layer molded by vulcanization molding is provided between the core wire and the intermediate canvas.

2. The timing belt according to claim 1, wherein the intermediate canvas is buried in the belt body.

3. The timing belt according to claim 2, wherein the belt body has an outer peripheral surface ground so as to make the thicknesses of the belt body uniform.

4. The timing belt according to claim 1, wherein the intermediate canvas is woven by woofs along the circumferential direction and warps along the width direction, the woof is formed of organic fibers, and the warp is formed of the organic fibers or inorganic fibers.

5. The timing belt according to claim 4, wherein the woof is made of a processed yarn having retractility.

6. The timing belt according to claim 5, wherein the processed yarn is crimp-processed.

7. The timing belt according to claim 5, wherein the processed yarn is constituted by winding at least one pile or more of covering yarns around the outer circumferential side of core yarns by using elastic yarns having retractility as the core yarns.

8. The timing belt according to claim 4, wherein the warp is made of aromatic nylon or carbon fiber.

9. The timing belt according to claim 4, wherein the woof and the warp are a twisted yarn having a diameter of 100 deniers to 2000 deniers.

10. The timing belt according to claim 1, wherein the intermediate canvas has a surface subjected to adhesive processing.
